(19) United States
(12) Patent Application Publication
(10) Pub. No.: US 2014/0356027 A1
(43) Pub. Date: Dec. 4, 2014

(54) DRIVE TRANSMISSION DEVICE AND IMAGE FORMING APPARATUS INCLUDING SAME

(71) Applicants: Kimiharu YAMAZAKI, Kanagawa (JP); Katsuaki MIYAWAKI, Kanagawa (JP); Tetsuo WATANABE, Kanagawa (JP); Hiromichi MATSUDA, Kanagawa (JP)

(72) Inventors: Kimiharu YAMAZAKI, Kanagawa (JP); Katsuaki MIYAWAKI, Kanagawa (JP); Tetsuo WATANABE, Kanagawa (JP); Hiromichi MATSUDA, Kanagawa (JP)

(73) Assignee: Ricoh Company, Ltd., Tokyo (JP)

(21) Appl. No.: 14/288,922

(22) Filed: May 28, 2014

(30) Foreign Application Priority Data
May 31, 2013 (JP) 2013-116487

(51) Int. Cl. G03G 15/00; F16H 1/20

(52) U.S. Cl. CPC F16H 1/20; G03G 15/757
USPC 399/167; 74/421 R

(57) ABSTRACT

A drive transmission device that transmits rotation from a drive source of an image forming apparatus to a rotary body detachably attachable relative to a main body thereof in an axial direction includes two external gears, a cylindrical member, and an intermediate-body retainer. The two external gears include teeth on an outer circumferential surface thereof extending in an axial direction. The cylindrical member includes an internal gear formed on an inner circumferential surface thereof to mesh with the external gears, and a flange on a portion of an outer circumferential surface of the cylindrical member, the flange including a projection. The intermediate-body retainer includes a depression to fit with the projection of the flange to prevent the cylindrical member from getting disengaged from the external gears. The external gears constitute a two-stage spline joint that meshes with the internal gear of the cylindrical member.

### CROSS-REFERENCE TO RELATED APPLICATIONS

This patent application is based on and claims priority pursuant to 35 U.S.C. §119 to Japanese Patent Application No. 2013-116487, filed on May 31, 2013, in the Japan Patent Office, the entire disclosure of which is hereby incorporated by reference herein.

### BACKGROUND

1. Technical Field

Exemplary aspects of the present invention generally relate to a drive transmission device that transmits rotation to a rotary body detachably attachable relative to an image forming apparatus an axial direction, and more particularly to an image forming apparatus including the drive transmission unit.

2. Description of the Related Art

There is known an image forming apparatus in which consumable parts such as a photosensitive drum, a charging device, a development device, and a cleaning device are constituted as a single, detachable/attachable unit, as an image forming unit, thereby allowing users to replace the consumable parts. In the known image forming apparatus, the image forming unit is detachably attachable relative to a main body of the image forming apparatus, and a driving force is transmitted from the main body to the photosensitive drum.

A tandem-type image forming apparatus includes four image forming units, one for each of the colors yellow, magenta, cyan, and black are arranged in tandem. Upon forming an image, these image forming units are installed in the main body of the image forming apparatus and rotary bodies such as the photosensitive drum, a development roller, and so forth need to be driven to rotate. A drive source as a motor and a decelerator are disposed on the main body side of the image forming apparatus in such a manner that the decelerator and the photosensitive drum are connected, enabling transmission of a driving force to the photosensitive drum.

Various approaches have been proposed for connection of the drive source and rotary bodies. For example, a spline coupling using an external gear and an internal gear is known. The image forming unit is detachably attachable. In this configuration, axis declination and axis eccentricity occur easily on an output shaft of the decelerator on the main body side of the image forming apparatus and on a shaft of the photosensitive drum connected to the output shaft. Furthermore, gear eccentricity and angular deviation occur on the shafts of the external gear and the internal gear which serve as a connecting device.

In view of the above, an image forming apparatus equipped with a device to secure replaceability and rotation transmission accuracy has been proposed in JP-2008-002671-A. This image forming apparatus includes a gear having tapered gear teeth with an oblique surface, the thickness thereof becoming less from the center of face width towards the edge of tooth. In this configuration, upon installation of the image forming unit, reliable spline coupling and rotation may be achieved.

However, in the connection device proposed in JP-2008-002671-A, the internal gear does not function as a cylinder-shaped member (sleeve) serving as an intermediate transmission member. Consequently, the tolerance in rotation transmission with respect to shaft deviations such as misalignment of shaft center, axis declination, axis eccentricity, and so forth is relatively small. Furthermore, workability, assemblage, and durability are not taken into consideration. That is, since the internal gear is fixed, the internal gear cannot tolerate misalignment as a cylindrical member. There may be a drawback to the foregoing configuration equipped with the intermediate transmission device in that repeated detachment/attachment and continuous operation may cause alignment shift and poor workability upon resin molding of the internal gear and the external gear.

In another example of transmission of rotational force, as proposed in JP-2009-204002-A, similar to the foregoing configuration, the image forming apparatus includes a spline coupling, and the gear teeth of the external gear are crowned such that the thickness in a pitch circle direction is at its maximum at the center in the axial direction. Therefore, a highly accurate connection device to prevent rotation transmission error while providing tolerances with respect to axis eccentricity and axis declination is proposed.

Gear parts are often made through injection molding. Injection molding is suitable for mass production of resin gears at low cost, and highly accurate gears can be produced using material having a high fluidity such as polyacetal resin. Generally, in the injection molding, the gear products having the above-mentioned tapered ends and crowned gear teeth can only be taken out from a mold by parting the mold consisting of a stationary mold and a movable mold. Separating the stationary mold and the movable mold on either a flat surface or a curved surface easily produces burrs or flash when excess pieces or scraps are attached linearly to the final product. For this reason, molding is not preferable to produce a gear that requires highly accurate teeth.

JP-4409782-B1 (JP-2002-273579-A) proposes another example of molding method to produce a gear having crowned teeth taking an advantage of characteristics of resin shrinkage or a sink mark. In this configuration, however, an amount of crowning attributed to the sink mark is approximately 40 μm, which does not provide a sufficient crowning amount such as proposed in JP-2009-204002-A, and furthermore, reliable and highly accurate crowning is difficult to perform.

JP-2011-197298-A proposes a two-stage gear coupling, which is disadvantageous in mounting a sintered gear in terms of durability relative to repeated detachment and attachment of the device.

### SUMMARY

In view of the foregoing, in an aspect of this disclosure, there is provided a novel drive transmission device that transmits rotation from a drive source of an image forming apparatus to a rotary body detachably attachable relative to a main body of the image forming apparatus in an axial direction of the rotary body includes two external gears, a cylindrical member, and an intermediate-body retainer. The two external gears include teeth on an outer circumferential surface thereof extending in the axial direction. The cylindrical member includes an internal gear formed on an inner circumferential surface thereof to mesh with the external gears, and a flange on a portion of an outer circumferential surface of the cylindrical member, the flange including a projection. The intermediate-body retainer includes a depression to fit with the projection of the flange to prevent the cylindrical member from getting disengaged from the external gears. The external gears constitute a two-stage spline joint that meshes with the internal gear of the cylindrical member.

An image forming apparatus includes the drive transmission device.

The aforementioned and other aspects, features and advantages would be more fully apparent from the following detailed description of illustrative embodiments, the accompanying drawings and the associated claims.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 is a schematic diagram illustrating an image forming apparatus according to an illustrative embodiment of the present disclosure;

FIG. 2 is a schematic diagram illustrating a photosensitive drum unit, a drive transmission device, and a connection device according to an illustrative embodiment of the present disclosure;

FIG. 3 is a schematic diagram illustrating the photosensitive drum unit, the drive transmission device, and the connection device according to another illustrative embodiment of the present disclosure;

FIGS. 4A through 4C are schematic diagrams illustrating a gear according to an illustrative embodiment of the present disclosure;

FIG. 5 is a cross-sectional view schematically illustrating a mold used in injection molding of gear parts including crowned teeth;

FIGS. 6A and 6B are schematic diagrams illustrating crowned gear teeth; and

FIGS. 7A and 7B are partially enlarged schematic diagrams illustrating a cylindrical member and an intermediate-body retainer.

### DETAILED DESCRIPTION

A description is now given of illustrative embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of this disclosure.

In addition, it should be noted that the terminology used herein is for the purpose of describing particular embodiments only and is not intended to be limiting of this disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In a later-described comparative example, illustrative embodiment, and alternative example, for the sake of simplicity, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but include other printable media as well.

Referring now to the drawings, wherein like reference numerals designate identical or corresponding parts throughout the several views, exemplary embodiments of the present patent application are described.

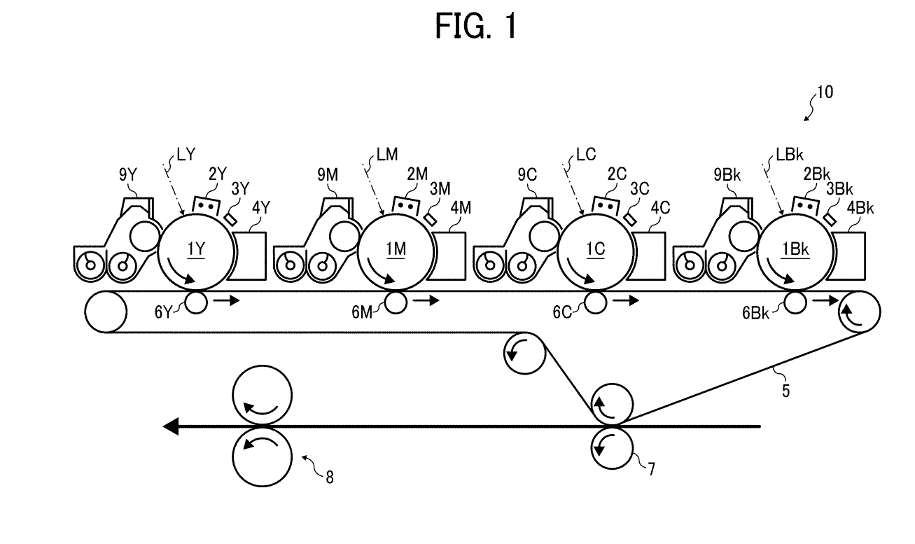

FIG. 1 is a schematic diagram illustrating an image forming apparatus in which a drive transmission device according to an illustrative embodiment of the present disclosure is employed.

The image forming apparatus illustrated in FIG. 1 is an electrophotographic, tandem-type color copier in which an electrostatic latent image is developed with a two-component dry developing agent, thereby forming a visible image. In the present illustrative embodiment, the image forming apparatus includes, but is not limited to a printer, a facsimile machine, a printer, and a multi-functional machine including one of these functions thereof.

The image forming apparatus shown in FIG. 1 receives image data as image information from an image reading unit and performs image forming operation. As illustrated in FIG. 1, the image forming apparatus includes four photosensitive drums 1Y, 1M, 1C, and 1Bk, each serving as a latent image bearing member, arranged in tandem along an intermediate transfer belt 5. It is to be noted that the suffixes Y, M, C, and Bk denote colors yellow, magenta, cyan, and black, respectively. To simplify the description, these suffixes Y, M, C, and Bk indicating colors are omitted herein, unless otherwise specified. The intermediate transfer belt 5 is formed into a loop and entrained around a plurality of rollers including a drive roller. The photosensitive drums 1Y, 1M, 1C, and 1Bk are arranged in tandem along the direction of movement of the intermediate transfer belt 5 and contact the intermediate transfer belt 5.

The photosensitive drums 1Y, 1M, 1C, and 1Bk are surrounded by various imaging equipment for the electrophotographic imaging. For example, charging devices 2Y, 2M, 2C and 2Bk, development devices 9Y, 9M, 9C, and 9Bk, cleaning devices 4Y, 4M, 4C and 4Bk, and charge removers 3Y, 3M, 3C, and 3Bk are respectively disposed around the photosensitive drums 1Y, 1M, 1C, and 1Bk in the order of electrophotographic process. The photosensitive drums 1Y, 1M, 1C, and 1Bk are mounted in a main body of the image forming apparatus in a detachably attachable manner in an axial direction of the photosensitive drums 1Y, 1M, 1C, and 1Bk.

A description is now provided of forming a full-color image by the image forming apparatus according to the present illustrative embodiment.

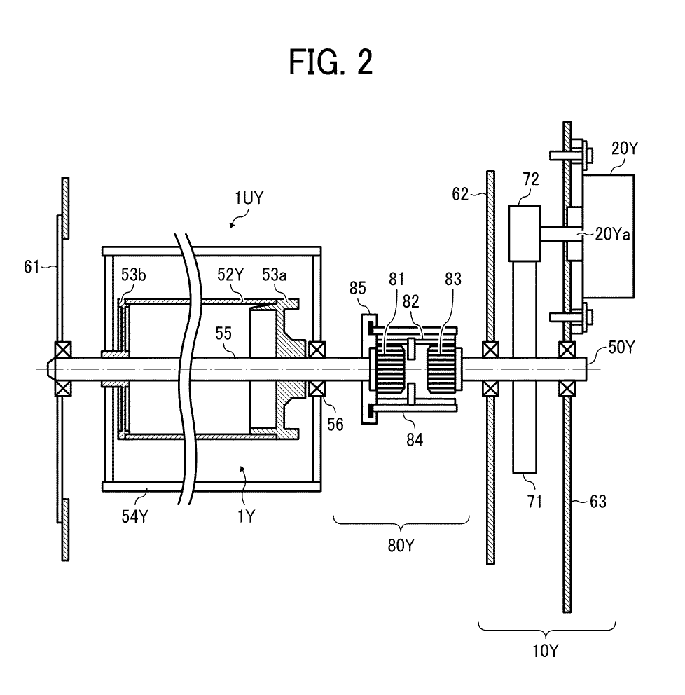

First, the photosensitive drum 1Y is rotated in the direction indicated by arrow by a photosensitive-drum driving device 10Y (shown in FIG. 2) and charged uniformly by the charging device 2Y while rotating. Subsequently, the photosensitive drum 1Y is illuminated with a light beam LY projected from an optical writing unit, thereby forming an electrostatic latent image of yellow on the surface of the photosensitive drum 1Y. The electrostatic latent image of yellow on the photosensitive drum 1Y is developed with yellow toner by the development device 9Y, thereby forming a visible image, also known as a toner image. Upon development, a predetermined development bias is applied between a development roller of the development device 9Y and the photosensitive drum 1Y so that the yellow toner on the development roller is attracted electrostatically to the electrostatic latent image on the photosensitive drum 1Y.

Subsequently, as the photosensitive drum 1Y rotates, the toner image of yellow formed on the surface of the photosensitive drum 1Y arrives at a primary transfer position at which the photosensitive drum 1Y contacts the intermediate transfer belt 5. At the primary transfer position, the predetermined bias voltage is supplied to the rear surface of the intermediate transfer belt 5 by a primary transfer roller 6Y disposed inside the looped intermediate transfer belt 5 across from the photosensitive drum 1Y. Application of the bias voltage generates a primary transfer electric field which causes the yellow toner image on the photosensitive drum 1Y to move to the intermediate transfer belt 5. This process is known as primary transfer.

Similar to the toner image of yellow, toner images of magenta, cyan, and black are formed on the photosensitive drums 1M, 1C, and 1Bk, respectively, and transferred onto the intermediate transfer belt 5 by primary transfer rollers 6M, 6C, and 6Bk such that they are superimposed one atop the other. Accordingly, a composite toner image is formed on the intermediate transfer belt 5.

Subsequently, the composite toner image formed on the intermediate transfer belt 5 is delivered to a secondary transfer position facing a secondary transfer roller 7, as the intermediate transfer belt 5 rotates. A transfer sheet such as a recording medium is fed to the secondary transfer position by a pair of registration rollers in appropriate timing such that the transfer sheet is aligned with the composite toner image formed on the intermediate transfer belt 5. At the secondary transfer position, the secondary transfer roller 7 supplies a predetermined bias voltage to the rear surface of the transfer sheet, thereby generating a secondary transfer electric field. The toner image on the intermediate transfer belt 5 is transferred onto the transfer sheet due to the secondary electric field and pressure applied at the secondary transfer position. Subsequently, the transfer sheet, on which the composite toner image is secondarily transferred, is delivered between a pair of fixing rollers 8 in a fixing unit. The toner image is fixed onto the transfer sheet by heat and pressure applied by the pair of the fixing rollers 8 as the transfer sheet passes between the fixing rollers 8.

### Embodiment 1

With reference to FIG. 2, a description is provided of an example of installation of a photosensitive drum assembly 1UY and the photosensitive-drum driving device 10Y connected thereto according to an illustrative embodiment of the present disclosure.

FIG. 2 shows the photosensitive drum assembly 1UY including the photosensitive drum 1Y employed in the image forming apparatus such as a printer as mentioned above, and a connecting mechanism 80Y that connects the photosensitive drum assembly 1UY to the photosensitive-drum driving device 10Y disposed on the main body side of the image forming apparatus. In the present illustrative embodiment, a description is provided of the photosensitive drum 1Y as an example of a drive target. The connecting mechanism 80Y may be employed for the development roller and the cleaning roller. Furthermore, the connecting mechanism 80Y can be employed for the drive roller in an intermediate transfer belt unit, the fixing roller in the fixing unit, and the secondary transfer roller in a secondary transfer unit.

It is to be noted that each of the photosensitive drums 1Y, 1M, 1C, and 1Bk as drive targets is rotated by a respective photosensitive-drum driving device having the same configuration as all the others. Thus, a description is provided of connection of the photosensitive drum 1Y and the photosensitive-drum driving device 10Y as a representative example.

As illustrated in FIG. 2, the photosensitive drum 1Y is mounted in the main body of the image forming apparatus such that the photosensitive drum 1Y is fitted to an external gear 71 on the main body side via the connecting mechanism 80Y. The photosensitive drum 1Y is composed of a cylindrical drum main body (hereinafter referred to simply as drum main body) 52Y, a front drum flange 53b at the front, and a rear drum flange 53a at the back. The front drum flange 53b and the rear drum flange 53a are fitted to each end of the drum main body 52Y. A drum shaft 55 (rotary shaft) supported by a shaft bearing 56 disposed on a frame 54Y of the photosensitive drum assembly 1UY is inserted through the center of the front drum flange 53b and the drum flange 53c . The drum shaft 55 is a metal shaft having an external diameter of approximately 10 mm.

The frame 54Y constitutes a housing of the photosensitive drum assembly 1UY that houses the photosensitive drum 1Y. When removing the photosensitive drum 1Y from the main body of the image forming apparatus for replacement or the like, the frame 54Y including the photosensitive drum 1Y is taken out from the main body of the image forming apparatus. An external gear 81 is disposed at the rear side of the drum shaft 55. The external gear 81 is a spline coupling output portion with the drum shaft 55 as the rotation center. The front side of the drum shaft 55 is supported by a shaft bearing disposed on a first plate 61 as a mounting plate and positioned in place in the main body of the image forming apparatus.

Next, with reference to FIG. 2, a description is provided of the photosensitive-drum driving device 10Y to drive the photosensitive drum 1Y.

The photosensitive-drum driving device 10Y disposed in the main body of the image forming apparatus includes a drive motor 20Y serving as a drive source, an external gear 72, the external gear 71, a drum shaft 50Y, and an external gear 83. The external gear 83 constitutes a spline coupling input. The drive motor 20Y is attached to a third frame 63 of the main body of the image forming apparatus. The external gear 72 is formed on a motor shaft 20Ya (drive shaft) of the drive motor 20Y. The external gear 72 mesh with the external gear 71. The external gear 71 is attached to the drum shaft 50Y to transmit a rotary driving power from the drive motor 20Y to the drum shaft 50Y. The drum shaft 50Y is supported by a shaft bearing attached to the third frame 63 and a shaft bearing attached to a second frame 62 constituting a frame of the main body of the image forming apparatus. The drum shaft 50Y is a metal shaft having an external diameter of approximately 10 mm.

The drum shafts 55 and 50Y of the photosensitive drum assembly 1UY employ a metal shaft having an external diameter of approximately 10 mm. Thus, the axial stiffness is relatively high on both the drive side and the driven side, and an amount of deformation or flexibility is small. With this configuration, low-frequency vibration is difficult to occur during image formation, hence preventing unevenness of image density, also known as banding which appears periodically in an image.

Although advantageous, the axial centers of the drum shaft 55 and the drum shaft 50Y are not aligned, thereby producing axis declination. The drum shafts 55 and 50Y are connected and fixed by screw fastening. When connecting using a coupling with a small range of error tolerance, a significant reaction force is generated on each shaft, thereby causing deformation of the photosensitive drum assembly 1UY and large vibration. It is to be noted that the photosensitive drum assembly 1UY may include, in addition to the photosensitive drum 1Y, the development device 9Y with the development roller, the charging device 2Y, the charge remover 3Y, and the cleaning device 4Y. In such a large photosensitive drum assembly, positioning accuracy upon assembly drops, and misalignment of shaft center and axis declination tend to increase.

In view of the above, the two-stage spline coupling is employed in the present illustrative embodiment. The two-stage spline coupling is known as a connecting mechanism with a wide range of error tolerance. An internal gear 82 is formed on an inner circumferential surface of a sleeve 84 as a cylindrical member. The internal gear 82 meshes with the external gear 81 and the external gear 83. Gear teeth extending in the axial direction are formed on the outer circumferential surface of the external gear 81 and the external gear 83. The thickness of the gear teeth in the pitch circle direction changes along the axial direction.

The external gear 81 and the external gear 83 mesh with the internal gear 82 on a specified effective tooth face. With this configuration, the external gear and the internal gear can tolerate axis declination without producing rotation transmission errors. There are two meshing portions that can tolerate the axis declination (i.e., the external gear 81 and the internal gear 82, and the external gear 83 and the internal gear 82). Thus, even when the shaft centers are not aligned, the inclination of the sleeve 84 on which the internal gear is formed can tolerate such misalignment. As described above, with the two-stage spline coupling, the sleeve 84 can swingably move in accordance with the axial errors, thereby absorbing deviations between the rotation center axis of the external gear 81 and the rotation center axis of the external gear 83. Rotary driving power is transmitted without producing the axial reaction force between two parallel shafts which are not on the same straight line and without changing the angular velocity.

Next, a description is provided of a configuration to enhance detachability/attachability of the connecting mechanism.

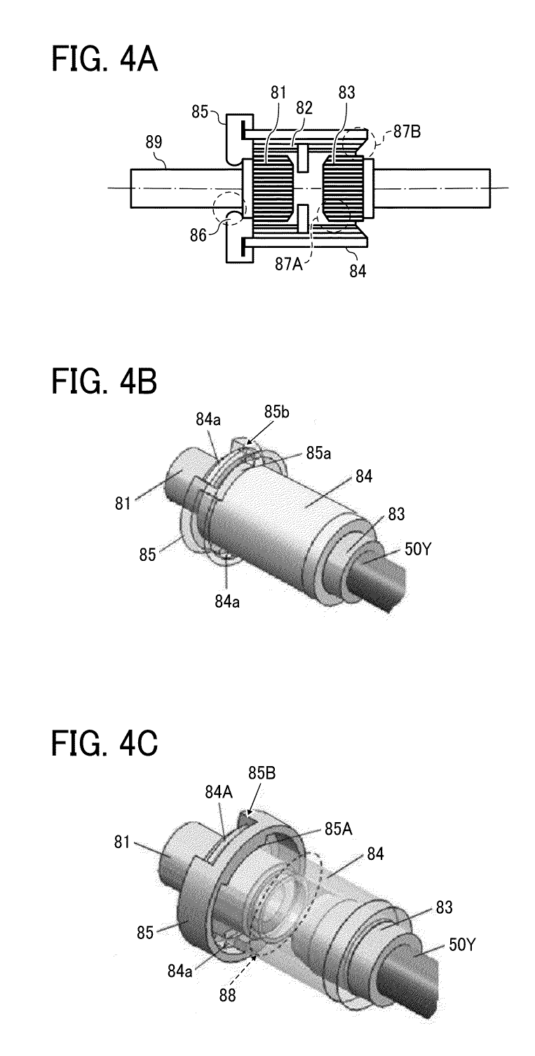

As illustrated in FIG. 2, the sleeve 84 has a two-stage structure in which a snap-fit portion 85a (shown in FIG. 4B) of a stopper 85 serving as an intermediate-body retainer is hooked on a step portion on a flange 84a of the sleeve 84 so that the internal gear 82 and the external gear 81 are prevented from falling. The leading end of the teeth of the external gear 83 in the axial direction has a tapered shape such that the thickness and the tooth depth thereof decrease, thereby facilitating meshing with the internal gear 82. For example, during retraction of the internal gear 82 and the sleeve 84, changes in the orientation of the internal gear 82 and the sleeve 84 allow the internal gear 82 and the sleeve 84 to achieve a proper meshing phase and to be connected with small rotation of the internal gear 82 and the sleeve 84.

Furthermore, backlash between the internal gear 82 and the external gear 81, and backlash between the external gear 71 and the external gear 72 allow the internal gear 82 and the sleeve 84 to achieve a proper meshing phase and to be connected with small rotation of the internal gear 82 and the sleeve 84. The tapered shape facilitates smooth attachment and detachment operation which may be performed repeatedly relative to the photosensitive drum assembly 1UY.

With this configuration, the internal gear 82 and the sleeve 84 are connected and swingably move, thereby absorbing misalignment of shafts and hence preventing rotation transmission errors. Accordingly, highly accurate rotation transmission is achieved. Generation of the axial reaction force upon connecting the driving device and the photosensitive drum assembly in a state in which the shafts are misaligned is suppressed, thereby forming an image with accuracy. Installation failure of these devices and damage to the connecting mechanism attributed to contact between the external gear 83 and the internal gear 82 when changing from a disengaged state to an engaged state can be prevented.

### Embodiment 2

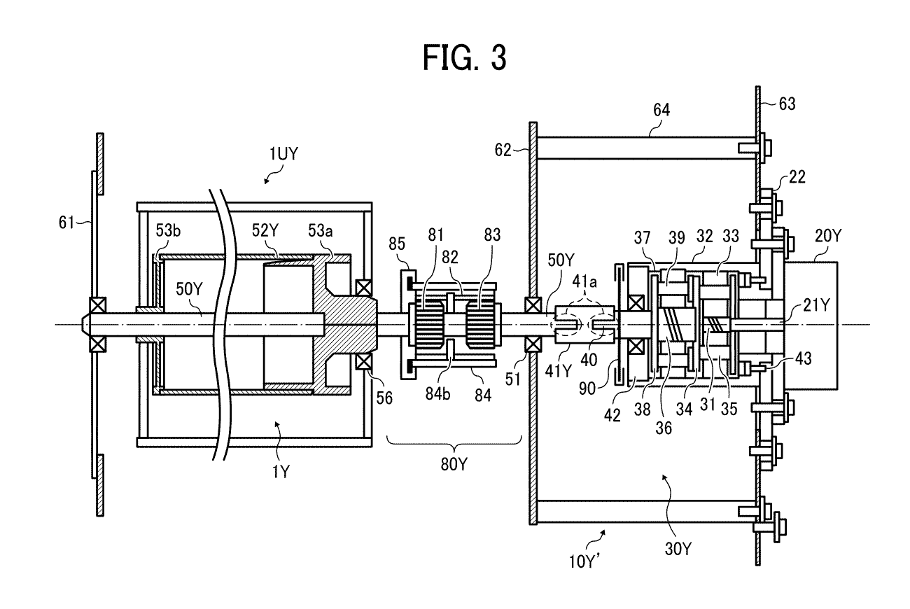

With reference to FIG. 3, a description is provided of another example of installation of the photosensitive drum assembly 1UY and a photosensitive-drum driving device 10Y′ connected thereto according to another illustrative embodiment of the present disclosure.

In the first illustrative embodiment, the rotary shaft (drum shaft 55) on the photosensitive drum assembly 1UY side and the rotary shaft (drum shaft 50Y) of the photosensitive-drum driving device 10Y side are connected. By contrast, in the second illustrative embodiment, the photosensitive drum assembly 1UY and the photosensitive-drum driving device 10Y′ use a common rotary drum shaft 50Y.

Conventionally, an output rotary shaft of the driving device at the image forming apparatus main body side is extended to a support position of the photosensitive drum 1Y to connect the hollow, photosensitive drum assembly 1UY to the rotary shaft. In this configuration, the photosensitive drum assembly 1UY is positioned in place relative to the rotary shaft so that misalignment of the shaft does not occur, allowing accurate transmission of the driving force. However, a similar problem to the misalignment of shaft still occurs depending on the parts accuracy of the connecting mechanism. For example, misalignment of the connecting mechanism similar to the misalignment of the shaft occurs due to eccentricity of the external gear formed on a flange of the photosensitive drum and eccentricity of the external gear press-fitted to the rotary shaft. As a result, rotation transmission errors and axial reaction force occur, causing similar degradation of imaging quality as described above.

According to the second illustrative embodiment, the drum shaft 50Y extending from the photosensitive-drum driving device 10Y′ as a driving unit penetrates through the photosensitive drum assembly 1UY. When using many parts such as when using a planetary gear assembly in the photosensitive-drum driving device 10Y′, the axial reaction force generated in the connecting mechanism affects engagement of the plurality of gears at the photosensitive-drum driving device side, and as a result, degradation of imaging quality tends to be significant.

Now, a description is provided of installation of the driving unit having a configuration different from the first illustrative embodiment and an example of the connection with the photosensitive drum assembly.

As illustrated in FIG. 3, the photosensitive-drum driving device 10Y′ includes the drive motor 20Y, a planetary gear decelerator 30Y, a connector 41Y, and the drum shaft 50Y. The planetary gear decelerator 30Y includes an output shaft 40. The output shaft 40 is connected to the drum shaft 50Y by the connector 41. A shaft bearing 51 is press fitted to the drum shaft 50Y. Via the shaft bearing 51, the drum shaft 50Y is supported and positioned in place by the second plate 62 constituting a rear side of the main body of the image forming apparatus. The shaft bearing of the first plate 61 at the front side which is fixed after the photosensitive drum is mounted supports the drum shaft 50Y.

With reference to FIG. 3, a description is provided of the configuration of the planetary gear decelerator 30Y.

According to the present illustrative embodiment, the planetary gear decelerator 30Y employs a two-stage 2K-H type planetary gear mechanism. In this example, the planetary gear mechanism includes two stages. Alternatively, depending on the required deceleration ratio, the planetary gear mechanism may include three or more stages. A first sun gear 31 is formed directly on an output shaft 21Y of the drive motor 20Y. A first planetary gear 33 of the first stage meshing with an internal gear 32 fixed to the first sun gear 31 and a bracket 22 is supported by a first carrier 34 of the first stage and revolves around the periphery of the first sun gear 31.

According to the present illustrative embodiment, a plurality of planetary gears, for example, three first planetary gears 33 are concentrically disposed for rotation balance and load dispersal. The number of planetary gears is not limited to three. More than three planetary gears can be used. Each of the first planetary gears 33 is supported by a first carrier pin 35 disposed on the first carrier 34 such that each of the first planetary gears 33 can rotate itself.

The plurality of first planetary gears 33 meshes with the first sun gear 31 and the internal gear 32 so that each of the first planetary gears 33 rotates while revolving around the first sun gear 31. The first carrier 34 supporting the first planetary gears 33 rotates slower than the rotation of the first sun gear 31, thereby obtaining a desired deceleration ratio at the first stage.

Next, a second sun gear 36 serves as an input for the second stage of the deceleration mechanism. The second sun gear 36 is provided at the center of rotation of the first carrier 34. It is to be noted that the first carrier 34 does not include a rotary supporting portion, thereby allowing the first carrier 34 to freely float (rotate). Similarly, a plurality of second planetary gears 37 of the second stage meshes with the second sun gear 36 of the second stage and the internal gear 32 extending to the second stage, and is supported by a second carrier 38 of the second stage. The internal gear of the first stage and the internal gear of the second stage are constituted as a single integrated unit as the internal gear 32. The second planetary gears 37 revolve around the periphery of the second sun gear 36.

Each of the second planetary gears 37 is supported by a second carrier pin 39 disposed on the second carrier 38 such that each of the second planetary gears 37 can rotate itself and revolve around the periphery of the second sun gear 36. The second carrier 38 of the second stage which is the last stage includes the output shaft 40 at the center of rotation of the second carrier 38. The output shaft 40 is connected to the drum shaft 50Y via the connector 41Y which is a hollow cylinder. The output shaft 40 of the second carrier 38 is supported by a shaft bearing press-fitted to an internal gear cap 42 positioned in place by the internal gear 32. The internal gear cap 42 is fitted to an inner circumference of the internal gear 32 and positioned in place. Accordingly, deviation of coaxiality between the output shaft 40 and the inter of axis of the internal gear can be minimized.

The connector 41Y is a hollow cylinder. The diameter of the drum shaft 50Y and the diameter of the output shaft 40 of the planetary gear decelerator are the same. The connector 41Y is press-fitted to the drum shaft 50Y and includes a notch 41a at the center thereof. The output shaft 40 is connected and fixed to the connector 41Y by a frictional force between a portion of the connector 41 pressed and bent by a screw.

As described above, the output shaft 21Y of the drive motor 20Y is supported by the bracket 22. The internal gear 32 is fixed to the bracket 22 by a screw 43. The bracket 22 fixedly holds the internal gear 32 and the drive motor 20Y. The bracket 22 is fixed to the third frame 63 using a screw. The third frame 63 is supported and positioned in place by a stud 64 fitted to the second plate 62 at the back side. The center of the shaft of the internal gear 32 at the drive motor side includes a hollow, cylinder-shaped boss. The inner circumference of the hollow, cylinder-shaped boss and the shaft bearing provided at the drive motor 20Y side are fitted together, thereby positioning the drive motor 20Y in place. The outer circumference of the hollow, cylinder-shaped boss is fitted to a hole of the bracket 22.

With this configuration, the axial centers of the output shaft 21Y, the bracket 22, and the output shaft 40 of the planetary gear decelerator 30 are coaxially disposed on the same axis with the internal gear being a reference, and the deviation of the coaxiality between these parts due to dimensional variations can be reduced, if not prevented entirely. In other words, the axial centers of the devices from the output shaft 21Y to the drum shaft 50Y are coaxially disposed on the same axis, and the deviation of the coaxiality between these parts due to dimensional variations can be reduced, if not prevented entirely.

Furthermore, a speed detector 90 is also disposed coaxially on the axial center of the internal gear, the output shaft 21, the bracket 22, and the output shaft 40 of the planetary decelerator. The speed detector 90 includes, for example, an encoder and two detectors. The configuration of the speed detector 90 is not limited thereto. The number of detectors may be changed as needed depending on a required control accuracy.

The photosensitive drum main body 52Y includes the flanges 53a and 53b disposed at each end of the photosensitive drum main body 52Y. The photosensitive drum main body 52Y is positioned in place relative to the drum shaft 50Y via the flanges 53a and 53b . The external gear 81 is formed integrally with the drum flange 53a . The external gear 81 and the drum flange 53a include a hole at the rotation center thereof, through which the drum shaft 50Y penetrates. The drum shaft 50Y is fitted to the hole and positioned in place. The external gear 83 is press fitted to the drum shaft 50Y. The external gear 83 transmits a driving force to the photosensitive drum main body 52Y. The photosensitive drum main body 52Y is driven via the external gear 81 fixed to the drum flange 53a , the internal gear 82, and the sleeve 84.

With the configuration described above, the motor output shaft, the internal gear, the second carrier, the output shaft of the planetary gear decelerator, the drum shaft, and the axial center of the photosensitive drum are all coaxially disposed on the same shaft, hence minimizing deviation of coaxiality.

Although advantageous, the rotation center of the external gear 81 may not be in alignment with the external gear 83 depending on the accuracy of press-fitting of the drum flanges 53a and 53b into the photosensitive drum main body 52Y, the accuracy of molding of the external gear 81 with the drum flange 53a , and the accuracy of molding of the external gear 83 press fitted to the drum shaft 50Y. The swingable movement of the internal gear 82 and the sleeve 84 absorbs the deviation of the rotation center, thereby transmitting the rotation with precision. In the second illustrative embodiment, the amount of axial deviation to be absorbed is less than that of the first illustrative embodiment. Therefore, the mating contact area is wide and the transfer stiffness is high.

FIG. 4A illustrates the shape of gears according to the illustrative embodiment of the present disclosure.

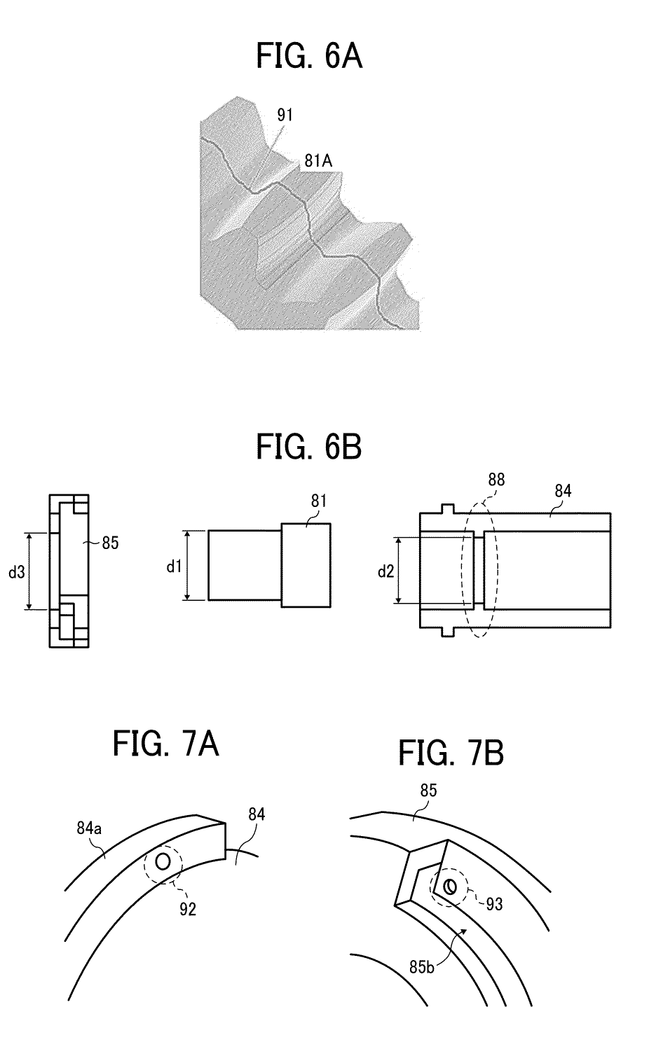

FIG. 4A is a cross-sectional view illustrating the external gear 81, the external gear 83, the sleeve 84, and the stopper 85 in an assembled state. The external gear 81 is a molded piece using resin. The teeth of the external gear 81 is crowned such as shown in FIG. 6A so that even when the sleeve 84 tilts due to misalignment, the internal gear 82 disposed inside the sleeve 84 can always mesh at the center of the face width. Furthermore, in order for the sleeve 84 to tilt more smoothly due to misalignment, the portion of the stopper 85 that contacts the cylinder portion of the external gear 81 is rounded (referred to as a rounded portion 86 shown in FIG. 4A). The external gear 83 includes a tapered portion 87A which allows the external gear 83 to mesh with the internal gear 82 of the sleeve 84 smoothly upon installation of the photosensitive drum assembly 1UY.

Also shown in FIGS. 6A through 7B, the sleeve 84 includes a pair of the flanges 84a disposed on the opposite side of the image forming apparatus main body (that is, the side that is mounted to the stopper 85). Alternatively, the stopper 85 may include a pair of grooves 85b to which the flanges 84a are fitted. The pair of grooves 85b is formed in such a manner that a portion of the outer circumferential surface of the stopper 85 opposite to the image forming apparatus main body is cut. The groove 85b makes the outer rim of the stopper 85 into a comb-like shape. With this configuration, at least one of the sleeve 84 and the stopper 85 is rotated about the shaft and assembled as shown as illustrated in FIGS. 4B and 4C.

According to the present illustrative embodiment as shown in FIGS. 4A through 4C, one of the two external gears 81 and 83, that is, the external gear 83, is assembled together with the sleeve 84 and the stopper 85 as a single integrated unit. The internal diameter of the stopper 85 is substantially smaller than the outside diameter of the external gear 83, but greater than the external diameter of a shaft 89. The sleeve 84 includes a partition 84b (shown in FIG. 3) that annularly projects from the inside of the sleeve 84. The internal diameter of the partition 84b is substantially smaller than the external diameter of the external gear 83. With this configuration, in a state in which the flanges 84a of the sleeve 84 are fitted reliably to the groove 85b of the stopper 85, the external gear 83 and the sleeve 84, and the stopper 85 are prevented from getting physically separated.

The teeth of the external gears 81 and 83 are crowned as illustrated in FIG. 6A and mesh with the internal gear 82 at the center of the face width. By contrast, the internal gear 82 is a straight spur gear. The internal gear 82 also includes a tapered portion 87B (indicated by a broken-line circle shown in FIG. 4A) which facilitates engagement and disengagement relative to the external gear 83 upon installation and removal of the photosensitive drum assembly 1UY.

As illustrated in FIG. 6A, in order to crown the external gear 81, the center of teeth of the external gear 81 is provided with a parting line 91. An external diameter d1 of the cylinder portion of the external gear 81 is smaller than the root diameter of the external gear to secure moldability using a mold. As illustrated in FIG. 6B, the center of the internal gear of the sleeve 84 includes a partition 88. The external gear 81, the sleeve 84, and the stopper 85 are assembled and inserted to the shaft 89. It is to be noted that in order to prevent damage upon inserting the shaft 89, the plane of the partition 88 of the sleeve 84 contacts the end portion of the external gear 81, thereby dispersing stress.

Furthermore, as illustrated in FIGS. 7A and 7B, the sleeve 84 includes a projection 92 having a spherical shape, and the stopper 85 includes a depression 93 having a hemispherical shape. The spherical projection 92 and the hemispherical depression 93 are fitted together and locked. Accordingly, the sleeve 84 is prevented from getting disengaged despite repeated operation. Providing the parting line 91 at the center of the face width allows a symmetric crowned shape relative to the center of the face width.

According to the present illustrative embodiment, the face width is approximately 5 mm, which is less than the face width of 10 mm of a single-stage spline coupling used in a known image forming apparatus. With a relatively short face width, rotation transmission characteristics tend to be enhanced. Furthermore, a relatively short face width reduces occupying space and increases durability because all teeth of the spline joint are designed to mesh. The teeth having a face width of 5 mm of the external gear at the photosensitive drum assembly 1UY side and the intermediate-body internal gear with a small diameter are crowned. Crowning is known to reduce rotation transmission errors. Thus, the two-stage spline joint with enhanced rotation transmission characteristics is obtained.

According to the present illustrative embodiment, in order to prevent damage to an intermediate-body retaining mechanism in the connector including an intermediate body, caused by attachment and detachment of the photosensitive drum assembly 1UY, the stress is received on a plane, thereby dispersing the stress. In order to increase the strength, there is an enhanced degree of freedom in the design such that the contact area and the thickness are increased.

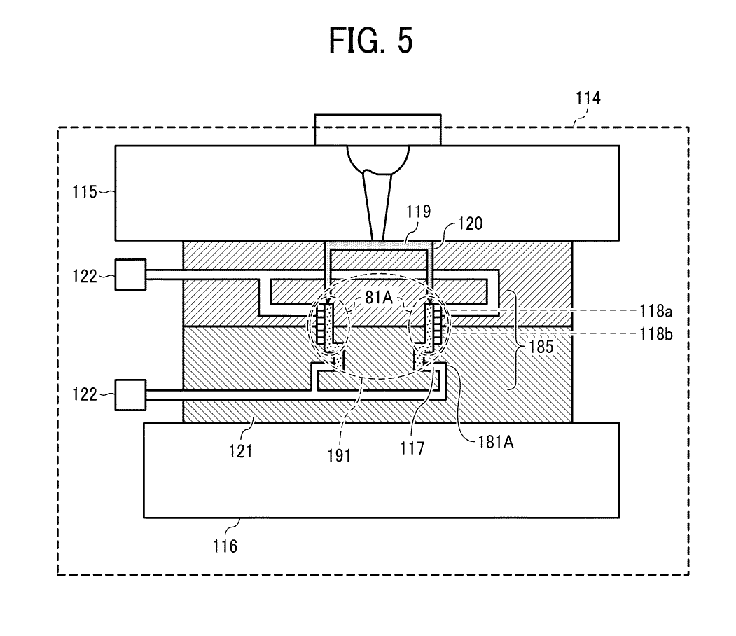

FIG. 5 is a vertical cross-sectional view schematically illustrating a mold used in injection molding of gear parts including crowned teeth. FIG. 6A illustrates the shape of the crowned tooth. FIGS. 7A and 7B illustrate the configuration to prevent undesirable disengagement of the cylinder-shaped member and the intermediate-body retainer.

Next, a description is provided of injection molding using molten resin and the mold used to produce the external gears 81 and 83 having crowned teeth. It is to be noted, however, for higher durability, preferably, the external gear 83 on the driving side located at the image forming apparatus main body side is a sintered gear. For functionality or for satisfying durability using resin, a resin gear may be employed. For example, to prevent abrasion and noise when tooth surfaces slidably contact, material that provides good slidability, for example, polyacetal (POM), may be used, preferably.

As illustrated in FIG. 5, a mold 114 includes a stationary upper platen 115 and a movable lower platen 116. A cavity 117 is formed in a place between a space of the upper platen 115 and the lower platen 116. The cavity 117 is a space formed mainly into a cylindrical shape, and molten resin is injected into the cavity 117 and cooled to be solidified. Accordingly, a cylindrical plastic molded product 191 is formed.

The upper platen 115 includes a path or runner 119 through which the molten resin is supplied and a plurality of pin gates 120 through which the molten resin supplied to the path 119 is injected into the cavity 117. The upper platen 115 and the lower platen 116 include a plurality of communicating holes 121 connected to the cavity 117. The plurality of communicating holes 121 is connected to compressed air supply sources 122. The internal diameter of the communicating holes 121, more specifically, the internal diameter of the opening of the communicating holes 121 at the cavity 117 side is in a range of from 0.001 to 0.5 mm.

In the present example, in order to form crowned external teeth 81A, a mold having parting lines 118a and 118b is used. According to the present illustrative embodiment, crowning refers to crowning in a direction of tooth thickness.

FIG. 6A illustrates an enlarged view of the external teeth 81A. As illustrated in FIG. 6A, the external teeth 81A are crowned such that the tooth thickness at the center of the face width is at its maximum and the tooth thickness at both ends in the direction of the face width is at its minimum. In order to form such crowned teeth through injection molding, it is necessary to split the mold at a portion where the tooth thickness is at its maximum. The parting line 91 for parting the mold indicates a boundary between the upper platen 115 and the lower platen 116. A half of the tooth profile of the external teeth 81A in the direction of the face width is transferred to the upper platen and the lower platen.

In the injection molding, when molding the cylindrical plastic molded product 191 using the mold 114, the molten resin flows in the path 119 (runner) and is supplied to the pin gate 120 through which the molten resin is injected into the cavity 117. The molten resin injected into the cavity 117 spreads radially with each pin gate 120 in the center. Consequently, the timing at which the molten resin injected into the cavity 117 reaches the end of the outer circumference side of the cavity 117 differs from the timing at which the molten resin reaches the end of the inner circumference side of the cavity 117. As a result, the amount of molten resin injected into the cavity 117 tends to be insufficient at the end portion of the outer circumference side of the cavity 117 or at the end portion of the inner circumference side of the cavity 117, at whichever side the molten resin arrives late.

The injected molten resin in the cavity 117 is cooled and solidified with time. During the solidification, when the resin pressure reaches a predetermined value, the compressed air supply source 122 is driven. Subsequently, the compressed air is blown from the communicating hole 121 into the cavity 117. The communicating hole 121 is formed to face the side surface of the cylindrical main body. With the compressed air blown against the cavity 117, a sink mark or depression is formed on the side surface of the cylindrical main body facing the communicating hole 121.

When such a sink mark is formed, the same amount of molten resin corresponding to the capacity of the sink mark is injected additionally into the end portion of the outer circumference side and the inner circumference side of the cavity 117. The position at which the sink mark is formed coincides with substantially the center of neighboring two pin gates. This position corresponds to the end of the outer circumference of the cavity 117 or the end of the inner circumference of the cavity 117, at whichever the injected molten resin arrives late and the amount of injected molten resin tends to be insufficient.

With this configuration, the molten resin is supplied additionally to the place at which the amount of the supplied molten resin is insufficient, thereby adjusting the variation in the amount of supplied molten resin and thus providing evenly the molten resin. Furthermore, this configuration also prevents wavy patterns or depression appearing on the tooth profile of an external tooth 181A of a transfer portion on an outer circumference side of the cylindrical main body. Accordingly, a molded product, i.e., a cylindrical plastic product having a gear molded with accuracy is obtained.

It is to be noted that by adjusting the driving timing and output of the compressed air supply source 122 the amount of compressed air to be supplied and supply timing can be adjusted as needed. Accordingly, the area and depth of the sink mark or depression can be adjusted. As a result of adjustment of the capacity of the sink mark or depression, the amount of molten resin to be injected additionally into the end portion of the outer circumference side and the end portion of the inner circumference side of the cavity 117 can be adjusted. This adjustment prevents more reliably wavy patterns or depressions appearing on the external tooth 181A on the transfer portion on the outer circumference side of the cylindrical main body, thereby obtaining a cylindrical plastic product with gear teeth molded with precision.

Furthermore, because the internal diameter of the communicating hole 121 is relatively small, i.e., in a range of from 0.001 mm to 0.5 mm, the molten resin injected into the cavity 117 is prevented from getting into the communicating hole 121, which then prevents burrs or flash which generally occurs when the molten resin gets into the communicating hole 121.

The gears in the drive transmission device according to the illustrative embodiments described above can be applied to a known single-stage spline coupling. For example, a rotary body rotatably driven may be a development roller, a development screw, a photosensitive drum, a transfer-driving roller, and the like disposed on the main body of the image forming apparatus or detachably attachable relative to the main body of the image forming apparatus. This configuration absorbs axial deviation and suppresses axial reaction force generated in the planetary gear mechanism, hence enabling highly accurate drive transmission.

According to the present illustrative embodiment, the drive transmission device employs a two-stage spline coupling using crowned gears which are excellent in workability, assemblage, and show good mechanical endurance against stress.

The drive transmission device of the present illustrative embodiment includes a two-stage spline coupling with a stopper having a groove that meshes with a rim formed on an outer circumferential surface of an internal gear while rotating. Furthermore, a projection and a depression are formed on the rim and the groove, respectively to fit with other upon insertion. An inner circumferential surface of the internal gear includes a circular rim with a diameter smaller than an outside diameter of an external gear. With this configuration, the external gear is prevented from falling off from the internal gear and getting damaged when an impact or a load is applied upon engagement.

The projection of the internal gear is fitted to the depression of the stopper, thereby preventing reliably undesirable disengagement of the internal gear and the stopper even when a load or vibration is applied thereto upon driving rotatably. Furthermore, the circular portion formed on the inner circumferential surface of the internal gear contacts the end portion of the external gear against loads in a direction of thrust upon detachment and attachment.

The drive transmission employed in the image forming apparatus of the present illustrative embodiment includes a two-stage spline joint employed at a connecting portion of the image forming apparatus. That is, in the present illustrative embodiment, a cylindrical member (i.e., a sleeve), which, in general, is not held by a retainer and hence moves easily in the direction of thrust, is prevented from moving in the direction of thrust by a stopper. A circular member is provided to the inside of the internal gear for impact and loads applied upon repeated attachment and detachment. With this configuration, the end surface of the circular member and the end surface of the external gear contact, thereby dispersing stress applied thereto. The two-stage spline coupling of the present illustrative embodiment is thus assembled with ease and has sufficient strength against impact and loads applied upon installation and detachment.

According to an aspect of this disclosure, the present invention is employed in the image forming apparatus. The image forming apparatus includes, but is not limited to, an electrophotographic image forming apparatus, a copier, a printer, a facsimile machine, and a digital multi-functional system.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. A drive transmission device that transmits rotation from a drive source of an image forming apparatus to a rotary body detachably attachable relative to a main body of the image forming apparatus in an axial direction of the rotary body, comprising:
two external gears including teeth on an outer circumferential surface thereof extending in the axial direction;
a cylindrical member including an internal gear formed on an inner circumferential surface thereof to mesh with the external gears, and a flange on a portion of an outer circumferential surface of the cylindrical member, the flange including a projection; and
an intermediate-body retainer including a depression to fit with the projection of the flange to prevent the cylindrical member from getting disengaged from the external gears,
wherein the external gears constitute a two-stage spline joint that meshes with the internal gear of the cylindrical member.

2. The drive transmission device according to claim 1, wherein the teeth of the external gears are crowned.

3. The drive transmission device according to claim 1, wherein the projection has a spherical shape and the depression has a hemispherical shape to fit with the spherical shape.

4. The drive transmission device according to claim 1, wherein one of the external gears on a main body side of the image forming apparatus is one of a sintered gear and a resin gear and is press fitted to a drive shaft of the drive source.

5. The drive transmission device according to claim 1, wherein one of the external gears disposed on the opposite side of the main body of the image forming apparatus is molded with polyacetal.

6. The drive transmission device according to claim 1, wherein the external gears include a parting line at the center of face width.

7. The drive transmission device according to claim 1, wherein a leading end of gear teeth of the internal gear and the external gears on a meshing side upon insertion is tapered.

8. The drive transmission device according to claim 1, wherein the intermediate-body retainer includes a groove to fit with the flange,
wherein the flange and the groove are fitted together by rotating, and the projection and the depression are fitted so as prevent the cylindrical member from getting disengaged from the external gears.

9. The drive transmission device according to claim 1, wherein one of the external gears is constituted as a single integrated unit with the cylindrical member and the intermediate-body retainer, and an internal diameter of the intermediate-body retainer is smaller than an outside diameter of the one of the external gears, but larger than an external diameter of the cylindrical member,
wherein the internal gear includes an annular partition having an internal diameter thereof substantially smaller than the external diameter of the one of external gears.

10. The drive transmission device according to claim 1, wherein the rotary body to which the drive transmission device transmits rotation of the drive source is disposed in the main body of the image forming apparatus or detachably attachable relative to the main body, and the rotary body is one of a development roller, a development screw, a photosensitive drum, and a transfer driving roller.

11. An image forming apparatus, comprising:
the drive transmission device according to claim 1.
